(19) United States
(12) Patent Application Publication
(10) Pub. No.: US 2018/0150194 A1
(43) Pub. Date: May 31, 2018

(54) THREE DIMENSIONAL HIERARCHICAL DATA DISPLAY

(71) Applicant: International Business Machines Corporation, Armonk, NY (US)

(72) Inventors: Jin Cao, Zhejiang (CN); Jialei Ma, Shanghai (CN); Hao Zhang, Shanghai (CN); Junqian Zhou, Shanghai (CN)

(21) Appl. No.: 15/851,806

(22) Filed: Dec. 22, 2017

Related U.S. Application Data
(63) Continuation of application No. 15/362,970, filed on Nov. 29, 2016.

(51) Int. Cl. G06F 3/0483; G06F 3/0481; G06F 17/30

(52) U.S. Cl. CPC G06F 3/0483; G06F 3/04815; G06F 17/30327; G06F 17/30126

(57) ABSTRACT

Embodiments provide receiving a hierarchical dataset comprising a plurality of tiers of data, wherein the plurality of tiers each comprise one or more nodes, creating a page corresponding to each of the plurality of tiers of data in a three-dimensional book model, drawing the one or more nodes for the corresponding tier of data on the created page for each created page; and enabling a user to view a selected page of the plurality of created pages via a graphical user interface.

### BACKGROUND OF THE INVENTION

The present invention relates generally to the field of data organization and storage, and more specifically to creating a three dimensional display of a hierarchical tree structure.

A tree structure or tree diagram is a way of representing the hierarchical nature of a structure in a graphical form. The tree hierarchy is an efficient way of organizing data of a complex nature because it enables users to retrieve a particular resource or data item quickly. A tree structure may be implemented in scenarios that require a user to manage or access large amounts of data. Such scenarios may be present with sophisticated web site maps, complicated database applications, and large lists of directories.

### SUMMARY

As disclosed herein, a method includes receiving a hierarchical dataset comprising a plurality of tiers of data, wherein the plurality of tiers each comprise one or more nodes, creating a page corresponding to each of the plurality of tiers of data in a three-dimensional book model, drawing the one or more nodes for the corresponding tier of data on the created page for each created page; and enabling a user to view a selected page of the plurality of created pages via a graphical user interface. A computer program product and computer system corresponding to the method are also disclosed.

### BRIEF DESCRIPTION OF THE DRAWINGS

FIG. 1 is a block diagram depicting a data processing system in accordance with one embodiment of the present invention;

FIG. 2 is a flowchart depicting a tree diagram display method in accordance with one embodiment of the present invention;

FIG. 3A depicts an example three-dimensional book display in accordance with one embodiment of the present invention;

FIG. 3B depicts an example three-dimensional book displaying a sub-tree in accordance with one embodiment of the present invention; and

FIG. 4 depicts a block diagram of components of a computer, in accordance with some embodiments of the present invention.

### DETAILED DESCRIPTION

Existing tree structure display methods include text-based representations, such as a text-based breadcrumb structure, as well as graphical structures available via a graphical user interface. A text-based breadcrumb structure may be displayed in the following manner:

Node A→Node B→Node C→Node D (1)

In example (1), Node D corresponds to a current node as selected by a user. The breadcrumb structure displays the hierarchy of the current node, but doesn't display any sibling nodes to the current Node D, or the parent Node C, or any of the other nodes in the hierarchy. Some graphical structures seek to alleviate this issue by displaying cascading lists for each tier of nodes. Listing each node in linear fashion can display all sibling nodes in some cases, but if too many nodes are present, a user may be unable to view the entire hierarchy of a current node along with all the sibling nodes. Displaying a hierarchical dataset using a three-dimensional tree diagram greatly increases the number of nodes that can be displayed to a user at any one time.

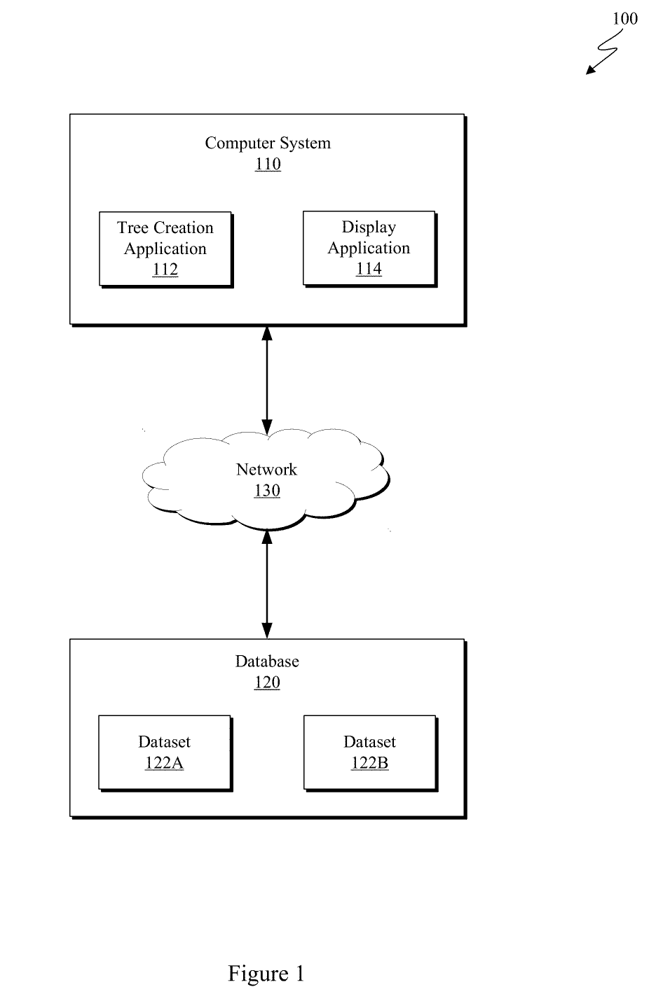

FIG. 1 is a block diagram depicting a data processing system 100 in accordance with at least one embodiment of the present invention. As depicted, data processing system 100 includes a computer system 110, database 120, and a network 130. Database system 100 may be an example of a system capable of creating and displaying a 3-D tree diagram of a hierarchical dataset.

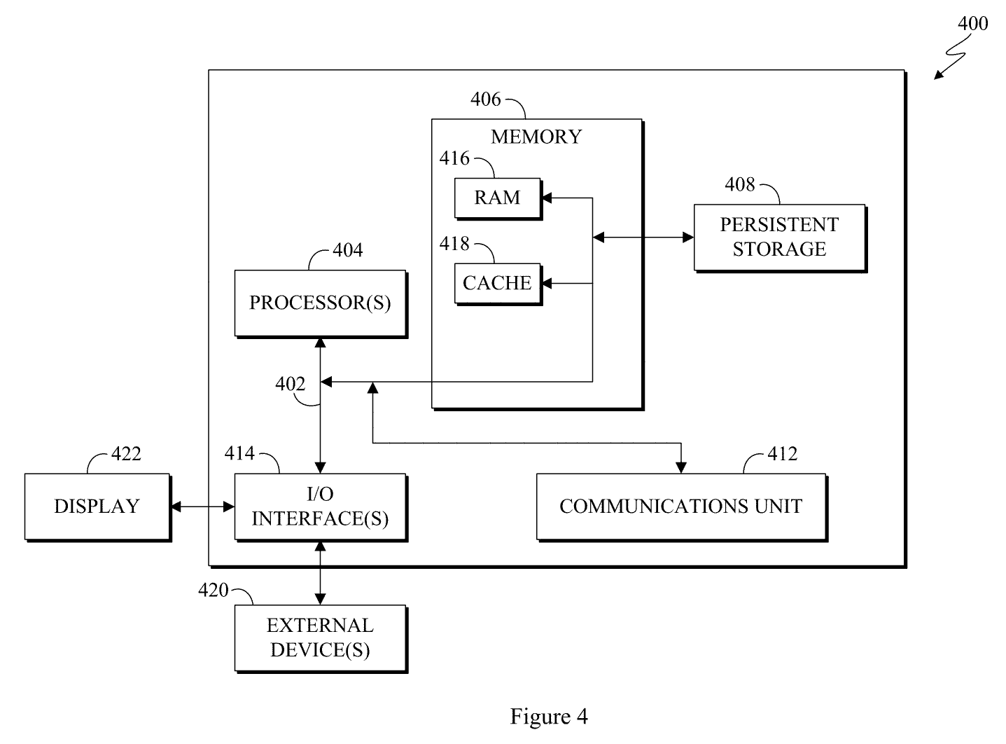

Computer system 110 can be a desktop computer, a laptop computer, a specialized computer server, or any other computer system known in the art. In some embodiments, computer system 110 represents a computer system utilizing clustered computers and components to act as a single pool of seamless resources. In general, computer system 110 is representative of any electronic device, or combination of electronic devices, capable of executing machine-readable program instructions, as described in greater detail with regard to FIG. 4.

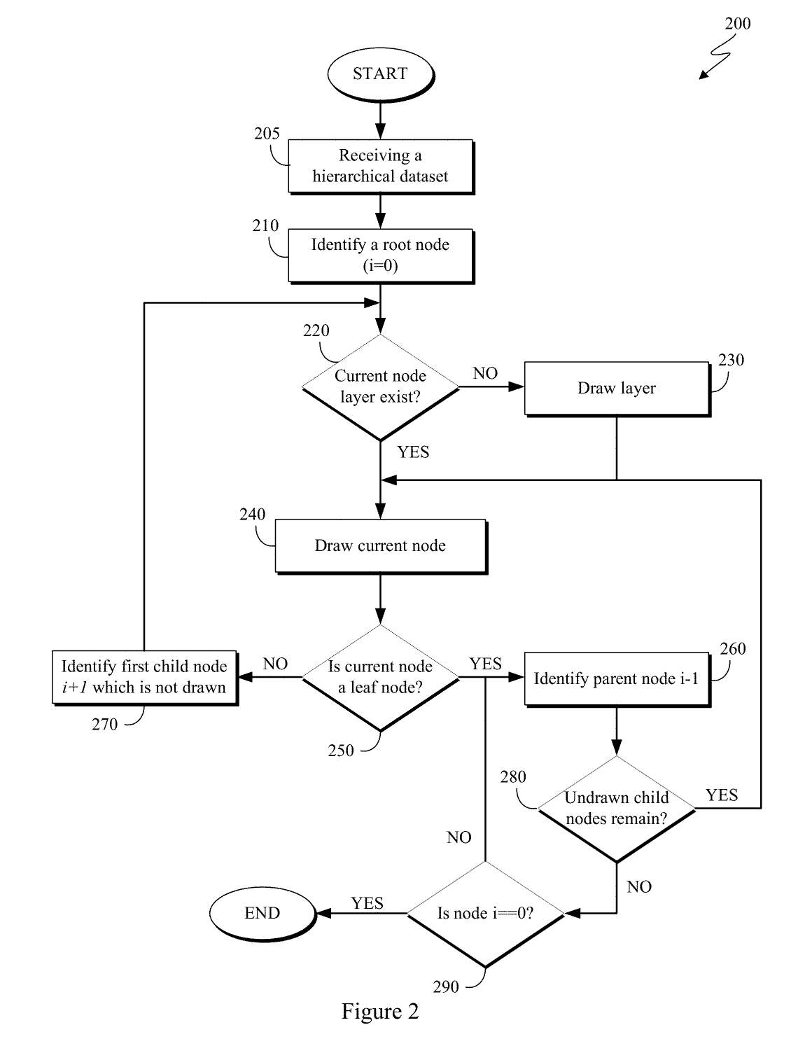

As depicted, computer system 110 includes a tree creation application 112 and a display application 114. Tree creation application 112 may be configured to receive a dataset, such as dataset 122A, from database 120. In some embodiments, tree creation application 112 is configured to execute a 3-D data display method on dataset 122A. One embodiment of an appropriate 3-D data display method is described in further detail with respect to FIG. 2. Display application 114 may be configured to receive a 3-D model of dataset 122A from tree creation application 112. In some embodiments, display application 114 is configured to display said received 3-D model of dataset 122A to a user via a display interface, such as is described with respect to FIG. 4.

Databases 120 may be collections of information that are organized to be easily accessed, managed, and updated. As depicted, database 120 includes one or more datasets 122. One or more of the datasets 122, such as dataset 122A, may be organized into hierarchical structures. In such an embodiment, computer system 110 receives dataset 122A for processing and display.

Network 130 can be, for example, a local area network (LAN), a wide area network (WAN) such as the Internet, or a combination of the two, and include wired, wireless, or fiber optic connections. In general, network 130 can be any combination of connections and protocols that will support communications between computer system 110 and database 120 in accordance with an embodiment of the present invention. In at least one embodiment of the present invention, network 130 transmits queries and data between computer system 110 and database 120.

FIG. 2 is a flowchart depicting a tree diagram display method 200 in accordance with at least one embodiment of the present invention. As depicted, tree diagram display method 200 includes receiving (205) a hierarchical dataset, identifying (210) a current node, determining (220) if a tier corresponding to the current node exists, drawing (230) the tier, drawing (240) the current node, determining (250) if the current node is a leaf node, identifying (260) a parent node i−1, identifying (270) a first child node i+1 that is not yet drawn, determining (280) whether any undrawn child nodes remain, and determining (290) whether or not the current node i==0. Tree diagram display method 200 may provide a graphical depiction of a set of hierarchical data.

Receiving (205), by a processing device, a hierarchical dataset may include receiving one or more data items sorted in a hierarchical manner. In one embodiment, the hierarchical dataset corresponds to a data tree. The received hierarchical dataset may include one or more data tiers, wherein each of the one or more data tiers includes one or more data nodes.

Identifying (210), by the processing device, a root node i may include identifying a root node within a hierarchical dataset. In a tree data structure, the root node is the very first or parent node. That is, a root node is a node that has only child nodes and no parent node. A child node is a node directly connected to another node that is a tier further from the root node than its parent node. A node that is reachable by repeated proceeding from parent node to child node is considered a descendant node. Similarly, a node that is reachable by repeated proceeding from child node to parent node is called an ancestor node. In some embodiments, any node in a tree structure can be a root node in relation to itself and its child nodes when considering a subset of the hierarchical dataset. The root node i may be defined as node 0. In at least one embodiment, identifying (210) a root node i includes selecting node i as a current node.

Determining (220), by the processing device, if a tier corresponding to the current node exists may include determining if a page has been drawn corresponding to a data tier the current node belongs to. On a first iteration of the method, no pages have been drawn, so it can be assumed a tier corresponding to the current node does not exist. If it is determined a tier corresponding to the current node does exist (220, yes branch), the method continues by drawing (240) the current node. If it is determined that a tier corresponding to the current node does not exist (240, no branch), the method continues by drawing (230) the tier.

Drawing (230), by the processing device, the tier corresponding to the current node may include creating a page in a three-dimensional book display corresponding to the tier in which the current node resides. In some embodiments, drawing (230) the tier corresponding to the current node includes creating a non-uniform rational basis spline (NURBS) model to represent the tier in the 3-D book. A NURBS surface is defined by its order, a set of weighted control points, and a knot vector. The control points determine the shape of the surface, and the knot vector is a sequence of parameter values that determine where and how the control points affect the NURBS curve. A uniform set of control points and knot vectors may be used to generate each page in the book display. In other embodiments, patch modeling or grid modeling may be utilized to draw the tier corresponding to the current node. Drawing (230) the tier may include assigning a number to the drawn page corresponding to the tier.

Drawing (240), by the processing device, the current node may include creating a graphical representation of the current node on the corresponding tier or page. In at least some embodiments, drawing (240) the current node may include determining if the current node shares a parent node with any nodes that have already been drawn. If the current node does share a parent node with one or more previously drawn nodes, then the current node may be drawn using a shared graphical indicator that is the same as the graphical indicator used for said previously drawn node(s). If the current node does not share a parent node with one or more previously drawn nodes, then the current node may be drawn using a different graphical indicator from any previously drawn nodes. Graphical indicators may correspond to colors or patterns used to depict the nodes to denote a shared parent node. Similarly to step 230, drawing (240) the current node may include utilizing patch modeling, grid modeling, or NURBS modeling to create the graphical representation of the current node.

Determining (250), by the processing device, if the current node is a leaf node may include determining whether node i has any child nodes. A leaf node is defined as a node that has no child nodes. In some embodiments, a leaf node may also be referred to as an external node. Nodes that have child nodes may be referred to as branch nodes or internal nodes. If it is determined that the current node is a leaf node (250, yes branch), the method continues by identifying (260) a parent node. If it is determined that the current node is not a leaf node (250, no branch), the method continues by identifying a first child node i+1 that is not yet drawn.

Identifying (260), by the processing device, a parent node i−1 may include identifying a node in a different tier that is connected to the current node i. In some embodiments, the parent node i−1 corresponds to a node that resides in a tier that is closer to the root node than the current node and that is directly connected to the current node. Identifying (260) a parent node i−1 may further include selecting node i−1 as the current node.

Identifying (270), by the processing device, a first child node i+1 that is not yet drawn may include identifying a node in a different tier that is connected to the current node i. In some embodiments, the child node i+1 corresponds to a node that resides in a tier that is further from the root node than the current node and that is directly connected to the current node. Identifying (270) a first child node i+1 may further include selecting node i+1 as the current node.

Determining (280), by the processing device, whether any undrawn child nodes remain may include identifying any child nodes corresponding to the current node in the hierarchical dataset. In some embodiments, determining (280) whether any undrawn child nodes remain includes identifying the number of child nodes with respect to the current node as well as the number of drawn nodes. If the number of child nodes with respect to the current node is less than the number of drawn nodes, then it can be assumed that undrawn child nodes remain. If it is determined that no undrawn child nodes remain (280, no branch), the method continues by determining whether the current node has a height of 0. If it is determined that one or more undrawn child nodes remain (280, yes branch), the method continues by selecting an undrawn child node as the current node and drawing (240) the current node.

Determining (290), by the processing device, whether the current node has a height of 0 may include determining the height of the current node. The height of a node is defined as the number of edges on the longest path between said node and a leaf node. If it is determined that the current node has a height of 0 (290, yes branch), the method terminates. If it is determined that the current node does not have a height of 0 (290, no branch), the method continues by identifying (260) a parent node of the current node.

Tree diagram display method 200 may additional include displaying the created three-dimensional book model corresponding to the hierarchical dataset. In some embodiments, displaying the created three-dimensional book model includes providing a graphical user interface through which the user may manipulate the display of the model. The user may be able to view one or more selected pages via the graphical interface.

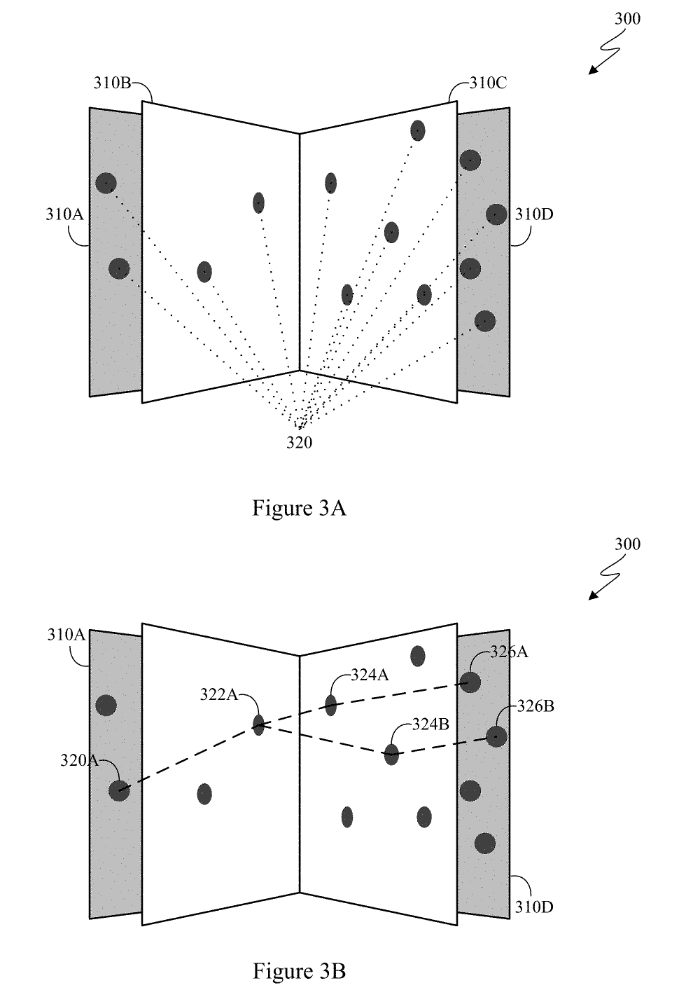

FIG. 3A depicts an example three-dimensional (3-D) book 300 depicting a tree hierarchy in accordance with one embodiment of the present invention. As depicted, the book 300 includes four pages 310 and a plurality of nodes 320. 3-D book 300 is an example of a 3-D model that provides comprehensive viewing of a hierarchical dataset in accordance with an embodiment of the present invention.

FIG. 3B depicts example edges between nodes as displayed on the example 3-D book 300 as depicted with respect to FIG. 3A. As depicted, 3-D book 300 includes four distinct pages 310, and each page 310 includes a plurality of nodes 320. FIG. 3B also depicts a subtree hierarchy between a subset of the nodes 320. As depicted, the subtree begins with a root node 320A drawn on page 310A. Root node 320A is connected to its only child node 322A drawn on page 310B via an edge depicted by a dotted line. As depicted, node 322A is a parent node to two child nodes 324A and 324B drawn on page 310C. Each node 324 has one child node each drawn on page 310D: node 324A is a parent node to node 326A and node 324B is a parent node to node 326B. The edges between each of these nodes are depicted by a dotted line. In at least one embodiment of the present invention, the dotted lines used to depict edges between nodes are depicted across multiple pages, and shift position appropriately when the position of a page is shifted.

FIG. 4 depicts a block diagram of components of computer 400 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

As depicted, the computer 400 includes communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses. Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media.

One or more programs may be stored in persistent storage 408 for access and/or execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links.

I/O interface(s) 414 allows for input and output of data with other devices that may be connected to computer 400. For example, I/O interface 414 may provide a connection to external devices 420 such as a keyboard, keypad, a touch screen, and/or some other suitable input device. External devices 420 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 408 via I/O interface(s) 414. I/O interface(s) 414 also connect to a display 422.

Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by a processing device, a hierarchical dataset comprising a plurality of tiers of data, wherein the plurality of tiers each comprise one or more nodes;
creating, by the processing device, a page corresponding to each of the plurality of tiers of data in a three-dimensional book model;
drawing, by the processing device, the one or more nodes for a corresponding tier of data on each created page, wherein child nodes which share a parent node are displayed using a shared graphical indicator wherein the shared graphical indicator corresponds to a pattern or color used to denote a shared parent node;
displaying one or more edges between one or more nodes, wherein the displayed one or more edges correspond to a selected sub-tree;
providing an interface enabling a user to manipulate a position of the one or more pages; and
enabling, by the processing device, a user to view a selected page of the plurality of created pages via a graphical user interface.
